(19) United States
(12) Patent Application Publication
(10) Pub. No.: US 2021/0062580 A1
(43) Pub. Date: Mar. 4, 2021

(54) Stabilization of Multi-Purpose Scaffold

(71) Applicant: Grady F. Smith, Greenville, NC (US)

(72) Inventor: Grady F. Smith, Greenville, NC (US)

(21) Appl. No.: 17/006,132

(22) Filed: Aug. 28, 2020

Related U.S. Application Data
(60) Provisional application No. 62/962,243, filed on Jan. 17, 2020.
(60) Provisional application No. 62/894,191, filed on Aug. 30, 2019.

(51) Int. Cl. E06C 1/39; E04G 1/24; E04G 1/20; E04G 5/16; E04G 7/02; E06C 1/397; E06C 7/16

(52) U.S. Cl. CPC E06C 1/39; E04G 1/24; E04G 1/20; E04G 2001/242; E04G 7/02; E06C 1/397; E06C 7/16; E04G 5/16

(57) ABSTRACT

Stabilization components are described for use with a lightweight scaffold comprising two ladder frames, an adjustable platform supported between the two ladder frames, and casters. Each ladder frames include two vertical supports connected by cross members. The platform comprises two side rails having guide channels at each end thereof that slide along the vertical supports. The casters includes stems that insert into the lower ends of the vertical supports. When installed, the stabilization components reduce shaking and swaying of the lightweight scaffold.

### RELATED APPLICATIONS

This application claims priority to U.S. Application No. 62/894,191, filed 30 Aug. 2019, and U.S. Application No. 62/962,243, filed 17 Jan. 2020, the entire disclosure of each being hereby incorporated by reference herein.

### TECHNICAL FIELD

The present disclosure relates generally to scaffolding and, more particularly, to components used for stabilizing a scaffold during use.

### BACKGROUND

Lightweight scaffolds made from metal tubing are commercially available for use when working close to the ground. One such scaffold comprises an adjustable platform supported between two ladder frames. The platform includes guide channels at each end that slide up and down along the vertical supports of the ladder frames. Casters insert into the lower ends of the vertical supports so that the scaffold can roll on the floor or other support surface. Also, the scaffolds are configured to be stacked vertically.

While lightweight scaffolds provide a low cost alternative to more heavy duty scaffolding when working close to the ground, such lightweight scaffolds lack the stability of more heavy duty scaffolds, particularly when the adjustable platform is raised high or when the scaffolds are stacked vertically. The lack of stability is due to excess play between components of the scaffold, lack of reinforcing, and the lightweight material used. Accordingly, there is a need for ways to improve the stability of commonly used lightweight scaffolds.

### SUMMARY

The present disclosure relates to stabilization of lightweight scaffolds that are readily available commercially. In the exemplary embodiments, the stabilization components are configured for use with a scaffold comprising two ladder frames, an adjustable platform supported between the two ladder frames, and casters. Each ladder frame includes two vertical supports connected by cross members. The platform comprises two side rails having guide channels at each end thereof that slide along the vertical supports. The casters includes stems that insert into the lower ends of the vertical supports.

According to one aspect of the disclosure, a clamping collar is provided to stabilize the connection between the vertical supports of the scaffold and the casters. The caster includes a wheel connected to a stem that inserts into the lower end of a vertical support. A clamping collar surrounds the lower end of the vertical support and includes a threaded screw that, when tightened, extends through an opening in the vertical support and presses the stem of the caster against the inner wall of the vertical support to remove play between the stem of the caster and the vertical support.

According to another aspect of the disclosure, a clamp is provided to stabilize the connections between the adjustable platform and the vertical supports of the ladder frames. The clamp comprises a C-shaped member, a pressure plate disposed inside the C-shaped member, and a threaded screw that threadably engages the C-shaped member and connects to the pressure late. The C-shaped member is configured to fit around the guide channels on the adjustable platform with the pressure plate oriented to engage the vertical support. When the threaded screw is tightened, the pressure plate presses the vertical support downward into the guide channel and against the back wall of the guide channel.

According to another aspect of the disclosure, one or more braces are provided to stabilize the scaffold when the platform is raised high or when two or more scaffolds are stacked. Each brace extends between respective one of the vertical supports and a respective side rail of the platform to prevent racking motion of the scaffold. The brace may include a clamp for engaging with the vertical support. The clamp comprises a channel, a pressure plate disposed within the channel, a bolt threadably engaged with the clamp. The channel is configured to fit around the corresponding vertical support. The pressure plate is configured to press the corresponding vertical support into an interior wall of the clamp, while the bolt, when tightened, presses the pressure plate into the corresponding vertical support.

The clamping collar, clamps and braces can be used separately or in combination to stabilize the lightweight scaffold.

### BRIEF DESCRIPTION OF THE DRAWINGS

FIG. 1 is a perspective view of a scaffold including two ladder frames and an adjustable platform according to one exemplary embodiment.

FIG. 2 is a partial perspective view of a side rail and guide channel for the adjustable platform.

FIG. 3 is an exploded perspective view a caster for the scaffold.

FIG. 4 is a perspective view of the compression collar.

FIG. 5 is a perspective view of a compression collar installed on the lower end of a vertical support to stabilize the connection between the vertical support and the caster.

FIG. 6 is a cross section through the lower end of a vertical support with a clamping collar installed.

FIG. 7 is a perspective view of a clamp.

FIG. 8 is perspective view of the clamp installed on the lower end of a guide channel to stabilize the connection between the guide channel and the vertical support on which the guide channel slides.

FIG. 9 is a cross section through the lower end of a guide channel with a clamp installed.

FIG. 10 is a perspective view of the auxiliary brace.

FIG. 11 is a perspective view of the scaffold with the compression collar, clamp and auxiliary brace installed.

FIG. 12 is a perspective view of a section of the scaffold with a stabilizer brace installed according to one embodiment of the present disclosure.

FIG. 13 is a perspective view of the stabilizer brace attached to a clamp, and the clamp releasably coupled to the scaffold according to one embodiment of the present disclosure.

FIG. 14 is a close-up view of the clamp connected to one of the vertical supports of the scaffold according to one embodiment of the present disclosure.

FIG. 15 is a perspective view of the clamp according to one embodiment of the present disclosure.

FIG. 16 illustrates the scaffold having a plurality of stabilizer braces installed thereon according to one embodiment of the present disclosure.

### DETAILED DESCRIPTION

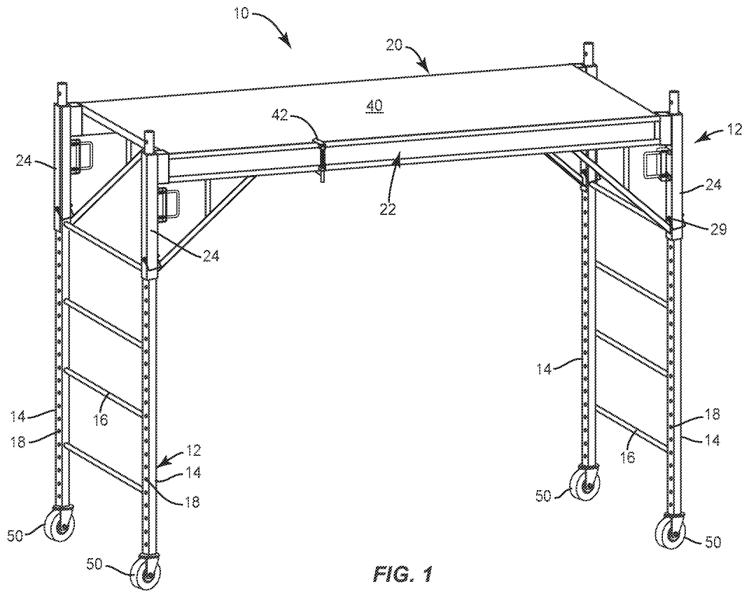

Referring now to the drawings, FIG. 1 illustrates a multi-purpose scaffold 10 according to an exemplary embodiment. The multi-purpose scaffold 10 comprises two ladder frames 12 and a platform 20 supported between the two ladder frames 12. The height of the platform 20 is adjustable.

Each ladder frame 12 comprises two vertical supports 14 connected by two or more cross members 16. The vertical supports 14 and cross members 16 are preferably made of a metal tubing or other tubular material. The cross members 16 are preferably welded at each end to respective ones of the vertical supports 14 so that each ladder frame 12 is a unitary structure. A series of openings 18 are formed in the vertical supports 14 and are spaced 2 inches apart. As will be hereinafter described in more detail, the openings 18 are engaged by a releasable locking mechanism 30 on the platform 20 to secure the platform 20 at a desired height between the ladder frames 12.

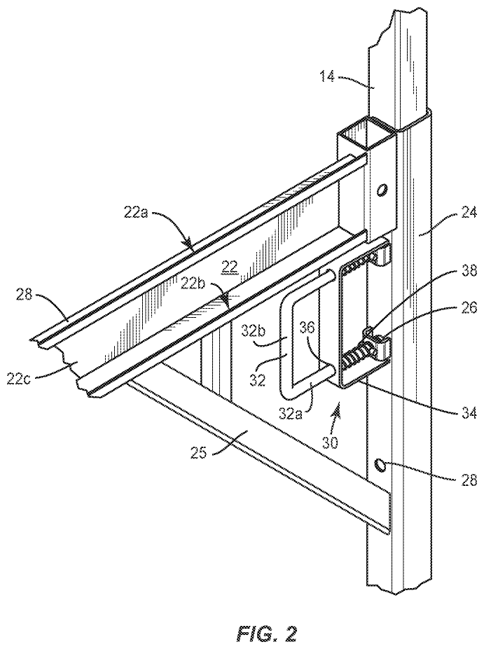

The platform 20 comprises two side rails 22 that extend between the ladder frames 12 and a deck 40 that is supported by the side rails 22. As seen in FIG. 2, the side rails 22 comprises an upper angle 22a and a lower angle 22b connected by a vertical wall 22c. The upper angle 22a defines a shoulder 28 on which the deck 40 rests. The deck 40 is held in place by security latches 42.

The side rails 22 connect at each end to a C-shaped guide channel 24 sized to fit around the vertical supports 14 of the ladder frames 12. The guide channels 24 are configured to slide along the vertical supports 14 of the ladder frames 12 at each end of the scaffold 10 to adjust the height of the platform 20. Two openings 26 are formed in the inner sidewall of each guide channel 24 near an upper end of the guide channel 24. The openings 26 are spaced to align with the openings 18 in the vertical supports 14 of the ladder frame 12 at preselected heights. The openings 26 in the guide channels 24 are engaged by a releasable locking mechanism 30 on the platform 20 to secure the platform 20 at a desired height between the ladder frames 12. A third opening 28 is formed near a lower end of the guide channel 24 and aligns with an opening 18 in the vertical support 14. A locking pin 29 passes through aligned opening 28 and 18 in the guide channel 24 and vertical support 14 respectively to lock to the guide channel 24 in place. The locking pin 29 thus provides additional safety in case the locking mechanism 30 inadvertently disengages. Diagonal braces 25 connect a lower end of each guide channel 24 to the side rail 22.

Each guide channel 24 includes a releasable locking mechanism 30 for locking the platform 20 at a desired height. In one embodiment, the releasable locking mechanism 30 comprises a U-shaped locking pin 32 that engages with the aligned openings 26 and 18 in the guide channel 24 and vertical supports 14 respectively to lock the side rail 22 at a desired height. Each locking pin 32 includes a pair of spaced apart legs 32a connected by a cross member 32b. An L-shaped bracket 34 supports the locking pin 32. The L-shaped bracket 34 includes a pair of openings 36 through which the legs 32a of the locking pin 32 extend. Springs 38 surrounding each leg 32a of the locking pin 32 bias the locking pin 32 to a locked position. The springs 38 are compressed when the locking pin 32 is pulled back to disengage the locking pin 36 and push the locking pin 32 back to an engaged position when the locking pin 32 is released.

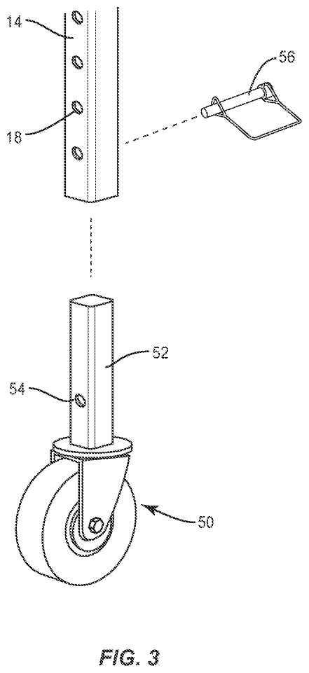

In some embodiments, the scaffold 10 includes casters 50 disposed at the lower end of each vertical support 14. Each caster 50 includes a stem 52 that extends into the lower end of a vertical support 14 as shown in FIG. 3. The stem 52 of the caster 50 includes an opening 54 that is located to align with an opening 18 in the vertical support 14 when the stem 52 of the caster 50 is inserted into the vertical support 14. The stem 52 is sufficiently long to overlap at least two openings 18 in the lower end of the vertical support 14. A locking pin 56 passes through aligned opening 54 and 18 in the caster 50 and vertical support 14 respectively to secure the caster 50 to the vertical support 14.

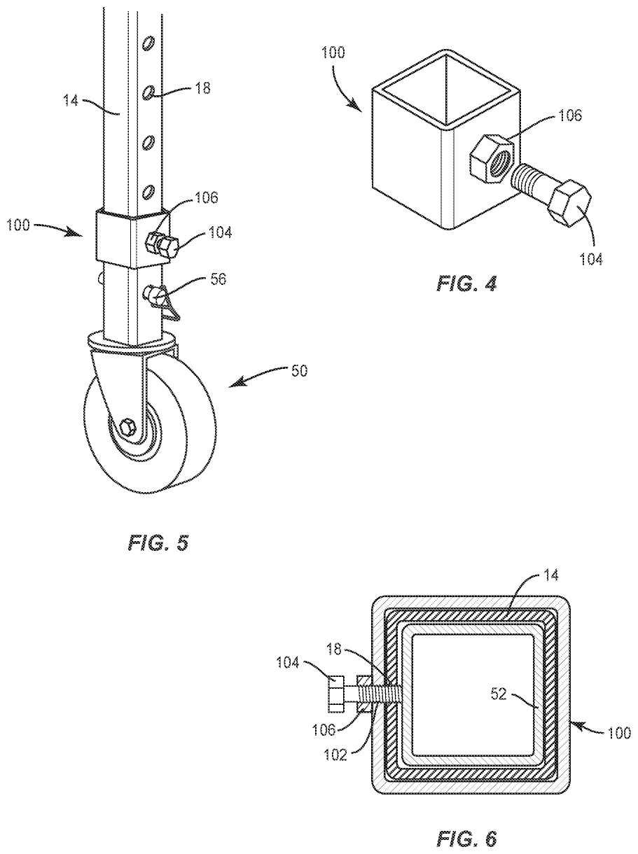

In some embodiments, the scaffold 10 as herein described includes a set of compression collars 100 to remove any play that may exist between the stems 52 of the casters 50 and the vertical supports 14 as shown in FIGS. 4-6. The compression collar 100 is similar (in a geometrical sense) in shape to the vertical supports 14 and is sized to fit around and slide over the lower end of a vertical support 14. The collar 100 includes an opening 102 that is aligned during use with one of the openings 18 in the vertical support 14. A nut 106 aligned with the opening 102 is welded to the outer surface of the collar 100. A bolt 104 is threadably engaged with the nut 106 on the collar 100. When tightened, the end of the threaded bolt 104 contacts the stem 52 of the caster 50 and presses the stem 52 of the caster 50 against the inner wall of the vertical support 14 to remove play between the stem 52 of the caster 50 and the inner wall of the vertical support 14.

In some embodiments, the caster 50 can be replaced by a footpad (not shown) or other ground-engaging member comprising a generally flat pad that contacts the ground or underlying surface and a stem that extends into that extends into the lower end of a vertical support 14. The footpad can be secured using the compression collar 100 in the same manner as the caster 50.

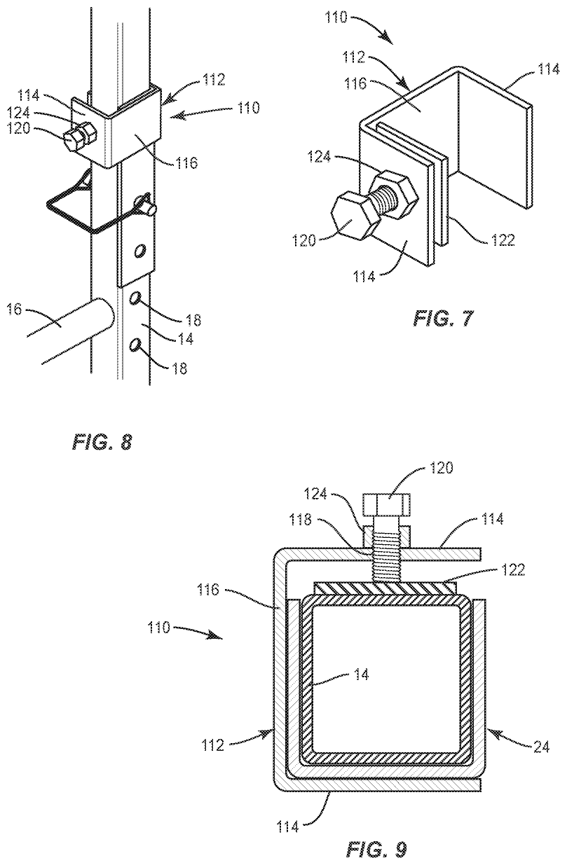

In some embodiments, the scaffold 10 further comprises a set of clamps 110 designed to stabilize the connections between the guide channels 24 and vertical supports as shown in FIGS. 7-9. The clamps 110 comprise a C-shaped channel 112 comprising flanges 114 connected by a central member 116. One of the flanges 114 includes an opening 118. A nut 124 aligned with the opening 118 is welded to the outer surface of the flange 114. A bolt 120 is threadably engaged with the nut 124 on the flange 114. A pressure plate 122 is connected to the end of the bolt 120. The pressure plate 122 may be fixedly attached or pivotally attached (e.g., via a ball joint) to the end of the bolt 120.

In use, the C-shaped channel 112 of the clamp 110 is placed around a guide channel 24 on the adjustable platform 20 with the pressure plate 122 on the open side of the guide channel 24. When the bolt 120 is tightened, the pressure plate 122 engages the vertical support 14 and presses the vertical support 14 downward into the guide channel 24 and against the back wall of the guide channel 24.

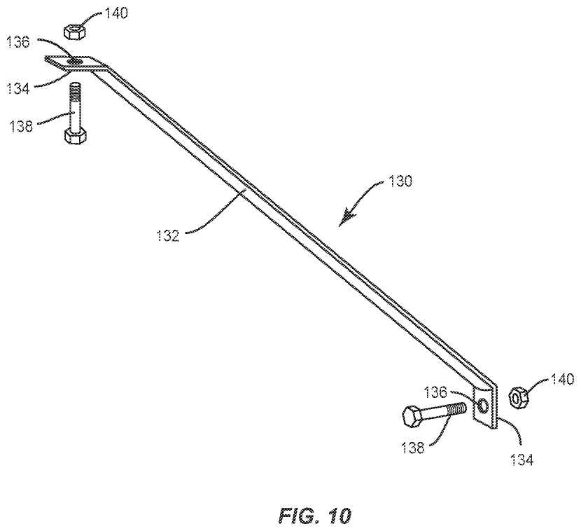

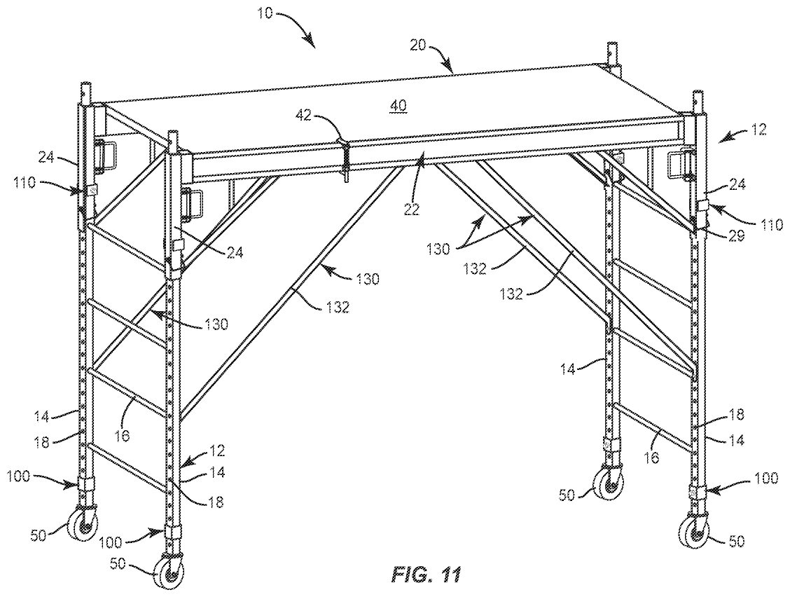

In some embodiments, the scaffold 10 further comprises four auxiliary braces 130 to prevent relative movement between the ladder frames 12 and platform due to play between the guide channels 24 and vertical supports 14 as shown in FIGS. 10 and 11. In one embodiments, each brace comprises a tubular rod 132 having flanges 134 at each end that are bent at an 45 degree angle approximately relative to longitudinal axis of the rod 132. Each brace 130 extends at a 45 degree angle between a respective one of the vertical supports 14 and a side rail 22. The flanges 134 include openings 136 for securing the auxiliary brace 130 to the side rail 22 and vertical support 134 respectively. The ends of the auxiliary brace 130 are secured by conventional bolts 138 and nuts 140. In particular, the opening 136 in the flange 134 at one end of the auxiliary brace 130 aligns with one of the openings 18 in a vertical supports 14. The bolt 138 passes through the aligned openings 18 and 136 in the vertical supports 14 and flange 134 respectively and is secured by tightening the nut 140. The opening 136 in the flange 134 at the other end of the auxiliary brace 130 aligns with an opening (not shown) in the side rail 22. The bolt 138 passes through the aligned openings in the side rail 22 and flange 134 respectively and is secured by tightening the nut 140.

When the auxiliary brace 130 is installed, adjustment in the height of the platform 20 is prevented. In some embodiments, the bolt 138 and nut 140 at the lower end of each brace 130 can be replaced by a quick connect coupling so that the braces 130 can be quickly connected and disconnected to adjust the height of the platform 20.

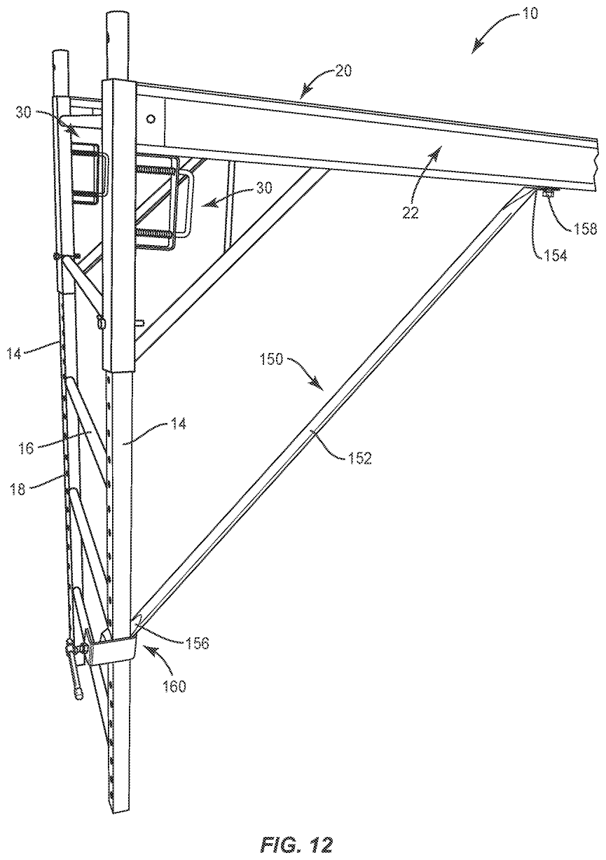

FIG. 12 illustrates the multi-purpose scaffold 10 configured according to another embodiment of the present disclosure. As in the previous embodiments, the multi-purpose scaffold 10 comprises two ladder frames 12, each comprising two vertical supports 14 connected by two or more cross members 16, and an adjustable platform 20 supported between the two ladder frames 12. Openings 18 are formed in the vertical supports 14 and are spaced 2 inches apart. As previously described, the openings 18 are engaged by the releasable locking mechanism 30 on platform 20 to secure the platform 20 at a desired height between the ladder frames 12.

In this embodiment, multi-purpose scaffold 10 also comprises one or more stabilizer braces 150 to prevent movement of the ladder frames 12 relative to platform 20. The stabilizer brace 150 is similar to the auxiliary brace 130 in that each stabilizer brace 150 also comprises a rigid, elongated support body, such as a tubular rod 152, having flanges 154, 156 at each terminal end of rod 152. The flanges 154, 156 are bent at a 45 degree angle approximately relative to a longitudinal axis of the rod 152. Each stabilizer brace 150 extends at a 45 degree angle between a respective one of the vertical supports 14 and a side rail 22.

One end of the stabilizer brace 150 is secured to the scaffold 10 using mechanical fasteners 158, such as a conventional bolt and nut. In particular, an opening (not shown but similar to opening 136 in FIG. 10) is formed in flange 154 that aligns with an opening (not shown) formed in side rail 22. The bolt passes through the aligned openings in the flange 154 and side rail 22, respectively, and is secured by tightening the nut.

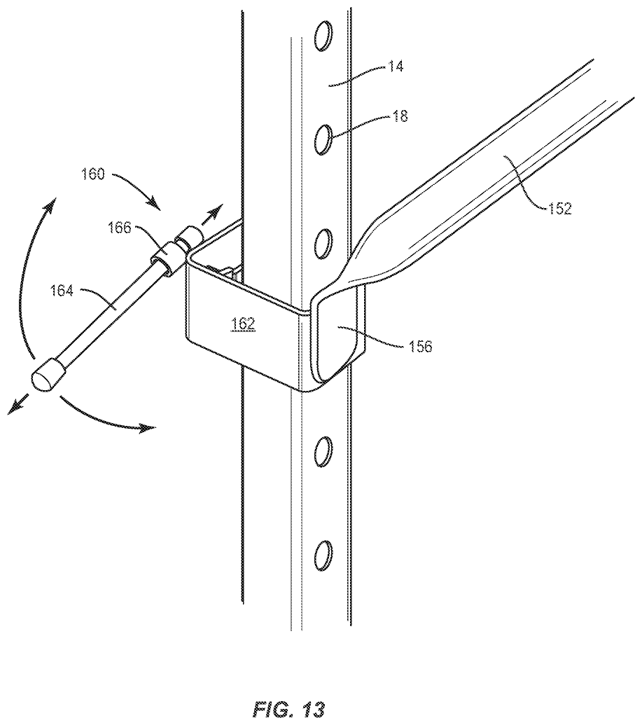

Flange 156, however, is not connected to vertical support 14 using a conventional nuts and bolts. Rather, flange 156 is fixedly attached to a clamp 160 that, in turn, is removably attached to a vertical support 14. In particular, as seen in the embodiment of FIG. 13, flange 156 is welded to an exterior surface of a wall 162 of clamp 160, although other methods of fixedly attaching the flange 156 are also possible. Clamp 160 fits around vertical support 14 and comprises a handle 164 configured to move back and forth through a receiver 166. The handle 164 is also configured to rotate in both clockwise and counterclockwise directions so as to tighten and loosen the clamp 160 from vertical support 14.

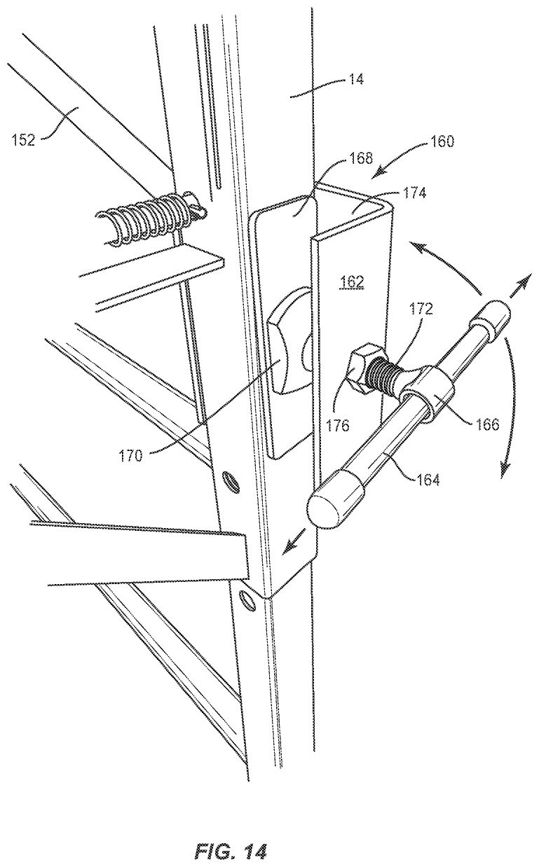

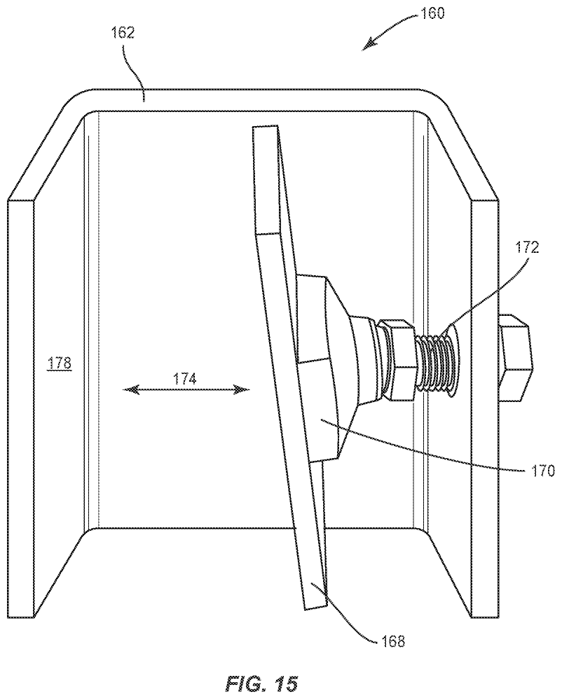

FIGS. 14-15 illustrate how clamp 160 is removably connected to vertical support 14 according to one embodiment. As seen in these figures, the wall 162 of clamp 160 forms a channel 174 that fits around the vertical support 14. Clamp 160 further comprises a pressure plate 168 pivotably attached to a bolt 172 via a pivot member 170. In this embodiment, the pivot member 170 comprises a ball joint movably connecting the pressure plate 168 to the bolt 172.

The bolt 172 extends through the wall 162 and is attached to a receiver 166. In one embodiment, bolt 172 is threadably attached to the wall 162. In other embodiments, however, bolt 172 threadably attaches to a nut 176 that is fixedly attached to wall 162. In any case, bolt 172 is attached to receiver 166 such that when a user rotates handle 164, the bolt 172 also rotates to move the pressure plate 168 towards and away from vertical support 14.

In use, the channel 174 of clamp 160 is placed around a vertical support 14. Rotating the handle 164 in the clockwise direction also rotates the bolt 172, thereby causing pressure plate 168 to move towards, and engage, the vertical support 14. Continued rotation of handle 164 causes the pressure plate 168 to press vertical support 14 against an interior surface 178 of wall 162. Rotating the handle 164 in the counterclockwise direction, however, also rotates bolt 172 thereby causing pressure plate 168 to move away from the vertical support 14. This movement releases the vertical support 14 from its pressing engagement against the back interior surface 178 of wall 162, thereby loosening the clamp 160 from vertical support 14.

It should be noted that handle 164, while facilitating the rotation of bolt 172, is not needed. In some embodiments, such as the one seen in FIG. 15, for example, the handle 164 and receiver 166 are not present. Instead, only the bolt 172 exists. Regardless, rotating the bolt 172 clockwise and counter clockwise causes the pressure plate 168 to move towards and away from vertical support 14, as previously described.

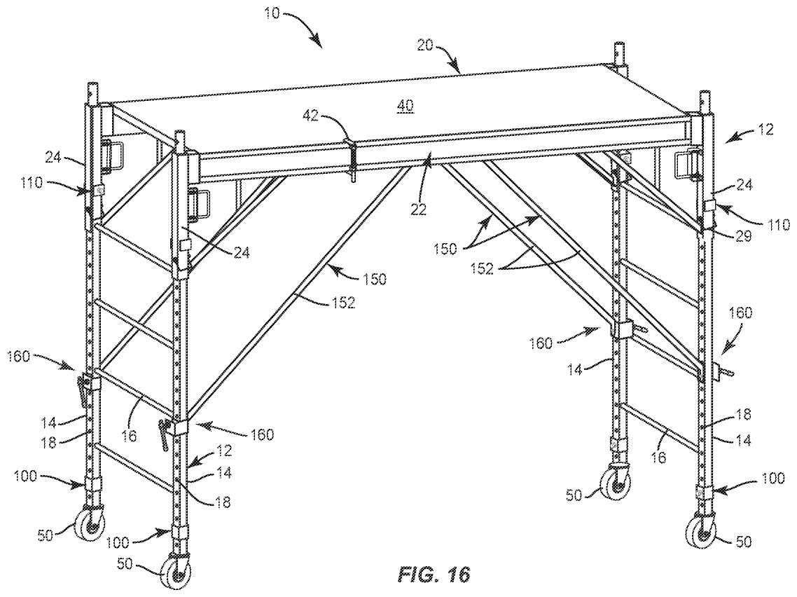

When the stabilizer brace 150 is installed, adjustment in the height of the platform 20 is prevented and the stability of the multi-purpose scaffold 10 is greatly enhanced. This is especially true when a plurality of stabilizer braces 150 are installed. FIG. 16, for example, illustrates an embodiment where four stabilizer braces 150 are installed. Further, because of its design, the stabilizer brace 150 is easily connected and disconnected from the multi-purpose scaffold 10.

The stabilization components as herein described remove excess play between components of the scaffold and prevent racking to provide greater stability. The increased stability enhances worker's confidence when standing on the scaffold.

What is claimed is:

1. A scaffold comprising:
first and second ladder frames, each ladder frame comprising two vertical supports made of a tubular material connected by two or more cross members;
a platform configured to be supported between the first and second ladder frames;
a ground-engaging member removably secured to a lower end of each vertical support, the ground-engaging member comprising a stem that extends into the lower end of a respective tubular vertical support;
a collar surrounding the lower end of at least one vertical support; and
a bolt threadably engaged with the collar and aligned with a first opening in the lower end of the at least one vertical support that, when tightened, extends through the opening and presses the stem of the ground-engaging member against an interior wall of the vertical support.

2. The scaffold of claim 1 further comprising:
an opening in the stem of the ground-engaging member that aligns with a second opening in the lower end of the at least one vertical support; and
a locking pin configured to pass through the second opening in the vertical support and the opening in the stem of the ground-engaging member to lock the ground engaging member to the vertical support.

3. The scaffold of claim 1 wherein the ground-engaging member comprises a caster.

4. The scaffold of claim 1 wherein the platform is adjustable.

5. The scaffold of claim 4 wherein the platform comprises:
first and second side rails extending between respective pairs of the vertical supports on the first and second ladder frames;
a pair of guide channels at opposing ends of each side rail configured to slide along respective ones of the vertical supports to adjust a height of the platform; and
a releasable locking mechanism on each guide channel to releaseably lock the guide channel at a desired position along vertical support;

6. The scaffold of claim 5 further comprising one or more clamps, each configured to clamp a respective one of the vertical supports in a corresponding one of the guide channels, each clamp comprising:
a channel configured to fit around the corresponding guide channel;
a pressure plate configured to engage the respective vertical support; and
a bolt threadably engaged with the channel and connected to the pressure plate that, when tightened, pushes the pressure plate into contact with the respective vertical support to clamp the vertical support in the guide channel.

7. The scaffold of claim 5 further comprising one or more braces configured to extend between a respective ones of the vertical supports and a respective side rail of the platform to reduce swaying when the platform is raised near a top of the ladder frames.

8. A scaffold comprising:
first and second ladder frames, each ladder frame comprising two vertical supports connected by two or more cross members;
an adjustable platform comprising:
first and second side rails extending between respective pairs of the vertical supports on the first and second ladder frames;
a pair of guide channels at opposing ends of each side rail configured to slide along respective ones of the vertical supports to adjust a height of the platform; and
a releasable locking mechanism on each guide channel to releaseably lock the guide channel at a desired position along vertical support;
one or more clamps, each configured to clamp a respective one of the vertical supports in a corresponding one of the guide channels, each clamp comprising:
a channel configured to fit around the corresponding guide channel;
a pressure plate configured to engage the respective vertical support; and
a bolt threadably engaged with the channel and connected to the pressure plate that, when tightened, pushes the pressure plate into contact with the respective vertical support to clamp the vertical support in the guide channel.

9. The scaffold of claim 8 wherein channel comprises a pair of opposing flanges connected by a central web and wherein the bolt is threadably engaged with one of the flanges.

10. The scaffold of claim 9 wherein the pressure plate is connected to the bolt by a ball joint.

11. The scaffold of claim 8 further comprising one or more braces configured to extend between a respective one of the vertical supports and a respective side rail of the platform to reduce swaying when the platform is raised near a top of the ladder frames.

12. A scaffold comprising:
first and second ladder frames, each ladder frame comprising two vertical supports connected by two or more cross members;
an adjustable platform comprising:
first and second side rails extending between respective pairs of the vertical supports on the first and second ladder frames;
a pair of guide channels at opposing ends of each side rail configured to slide along respective ones of the vertical supports to adjust a height of the platform; and
a releasable locking mechanism on each guide channel to releaseably lock the guide channel at a desired position along vertical support;
one or more braces configured to extend between a respective ones of the vertical supports and a respective side rail of the platform to reduce swaying when the platform is raised near a top of the ladder frames.

13. The scaffold of claim 12 further comprising one or more clamps, each attached to a lower end of one of the braces and configured to clamp a respective one of the vertical supports.

14. The scaffold of claim 13 wherein the clamp comprises:
a channel configured to fit around the corresponding vertical support;
a pressure plate disposed within the channel and configured to press the corresponding vertical support into an interior wall of the clamp;
a bolt threadably engaged with the clamp that, when tightened, presses the pressure plate into the corresponding vertical support; and

15. The scaffold of claim 14 wherein the clamp comprises first and second opposing flanges connected by a central web, and wherein the bolt is threadably engaged with the first flange.

16. A stabilization device for a scaffold having a vertical support with a ground-engaging member at the lower end thereof, the stabilization device comprising:
a collar configured to surround a lower end of the vertical support; and
a bolt threadably engaged with the collar that, when tightened, extends through an aligned opening on the vertical support to press a stem of the ground-engaging member against an interior wall of the vertical support.

17. A stabilization device for a scaffold including an adjustable platform with a guide channel that slide along a vertical support, the stabilization device comprising:
a channel configured to fit around the guide channel, the guide channel comprising opposing flanges connected by a central web;
a pressure plate configured to engage the respective vertical support; and
a bolt threadably engaged with one of the flanges of the channel and connected to the pressure plate that, when tightened, pushes the pressure plate into contact with the vertical support to clamp the vertical support in the guide channel.

18. A stabilization device for a scaffold including an adjustable height platform with one or more vertical supports, the stabilization device comprising:
a channel comprising opposing flanges connected by a central web configured to fit around a respective vertical support;
a pressure plate configured to engage the respective vertical support; and
a bolt threadably engaged with one of the flanges of the channel and connected to the pressure plate that, when tightened, pushes the pressure plate into contact with the vertical support to clamp the vertical support in the channel.
